(19) United States
(12) Patent Application Publication
(10) Pub. No.: US 2026/0244312 A1
(43) Pub. Date: Aug. 20, 2026

(54) INFORMATION PROCESSING APPARATUS, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: KEITA OGASAWARA, Saitama (JP)

(21) Appl. No.: 19/541,539

(22) Filed: Feb. 17, 2026

(30) Foreign Application Priority Data
Feb. 19, 2025 (JP) 2025-025153

(51) Int. Cl. G06F 3/0482; G06V 30/10; G06V 30/224

(52) U.S. Cl. CPC G06F 3/0482; G06V 30/10; G06V 30/224

(57) ABSTRACT

An image processing unit performs character string extraction on obtained scanned image data. The image processing unit performs item name extraction on obtained character recognition information. The image processing unit determines an item name based on the character recognition information and estimates an item name for a character string that is not determined to be an item name. The image processing unit performs integration processing and separation processing on the obtained item name. A display control unit displays a list of extracted item names on a touch panel of a display·operation unit, and receives, from a user, selection of an item name extracted from the list of item names displayed on the display·operation unit. The display control unit sets and registers the selected item name as an extraction item for extraction rule to be created.

### BACKGROUND

### Field of the Technology

The present disclosure relates to an information processing technology for performing item extraction on a scanned image.

### DESCRIPTION OF THE RELATED ART

There has conventionally been a system that scans and computerizes a paper document, and performs item extraction of extracting, as a character string, an item value corresponding to an item name set in advance, from a computerized scanned image. Japanese Patent Laid-Open No. 2024-33878 discloses a technology in which a user sets an item name to be extracted, by, in a setting screen, manually inputting the item name or by selecting the item name from candidates for the item name that are registered in advance, and an item value corresponding to the set item name to be extracted is extracted from a scanned image as a character string.

However, in the technology of Japanese Patent Laid-Open No. 2024-33878, if there are a large number of items to be extracted, there is a case where the number of unregistered item names is large, which leads to a problem that it takes time and effort for registration because the user has to manually input a large number of item names.

### SUMMARY

The present disclosure includes: an obtaining unit configured to obtain character recognition information for a scanned image of a document; a deriving unit configured to derive, based on the obtained character recognition information, an item name corresponding to an item value included in the character recognition information; and a display control unit configured to cause a UI screen to display the derived item name as a candidate of an item name corresponding to an item value extracted from a scanned image of a document of the same type as the document, wherein in a case where an item name corresponding to the item value included in the character recognition information does not exist in the character recognition information, the deriving unit estimates an item name corresponding to the item value based on the item value included in the character recognition information,.

Features of the present disclosure will become apparent from the following description of embodiments with reference to the attached drawings.

### BRIEF DESCRIPTION OF THE DRAWINGS

FIG. 1 is a diagram showing an example of a configuration of an information processing system in an embodiment;

FIG. 2 is a diagram showing an example of a hardware configuration of an image forming apparatus in an embodiment;

FIG. 3 is a diagram showing a functional configuration of the image forming apparatus in an embodiment;

FIG. 4 is a flowchart for explaining an entire processing of the information processing system in an embodiment;

FIG. 5 is a diagram showing an example of an extraction rule list screen in an embodiment;

FIG. 6 is a diagram showing an example of an extraction rule new creation screen in an embodiment;

FIG. 7 is a flowchart for explaining processing of creating an extraction rule in a first embodiment;

FIG. 8 is a flowchart for explaining processing of item name extraction in the first embodiment;

FIG. 9 is a diagram showing an example of scanned image data;

FIG. 10A is a diagram showing an example of an extraction item selection screen in an embodiment;

FIG. 10B is a diagram showing an example of an extraction item selection screen in an embodiment;

FIG. 11 is a diagram showing an example of a screen during selection of an extraction rule in an embodiment;

FIG. 12A is a diagram showing an example of a prompt for item name extraction to be inputted into a text generation model for item name extraction in a second embodiment;

FIG. 12B is a diagram showing an example of output of the text generation model for item name extraction in the second embodiment;

FIG. 13A is a diagram showing an example of a format of a prompt for item extraction to be inputted into the text generation model for item extraction in the second embodiment;

FIG. 13B is a diagram showing an example of the prompt to be inputted into the text generation model for item extraction in the second embodiment;

FIG. 13C is a diagram showing an example of output in a case where the prompt is inputted into the text generation model for item extraction in the second embodiment;

FIG. 14 is a flowchart for explaining item name extraction in a fourth embodiment; and

FIG. 15 is a diagram showing an example of an extraction item selection screen in the fourth embodiment.

### DESCRIPTION OF THE EMBODIMENTS

Hereinafter, modes for carrying out the present disclosure will be described by using the drawings. Note that the following embodiments are not intended to limit the invention according to Claims, and all the combinations of features described in the embodiments are not necessarily essential for the solution of the invention.

### First Embodiment

### System Configuration

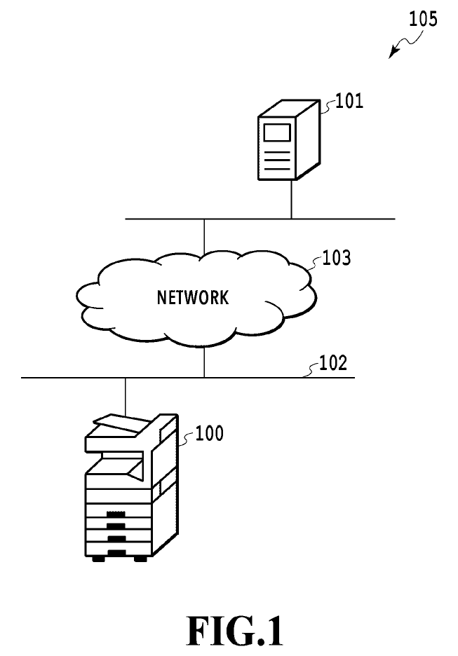

FIG. 1 is a diagram showing an overall configuration of a system to which the present embodiment can be applied. A system 105 of the present embodiment includes an image forming apparatus 100 and a terminal 101. As shown in FIG. 1, the image forming apparatus 100 is connected to a LAN 102, and is capable of communicating with the terminal 101 or the like such as a PC via a network 103 such as the Internet. Note that in the present embodiment, the terminal 101 does not have to be present, and a configuration including only the image forming apparatus 100 may be employed.

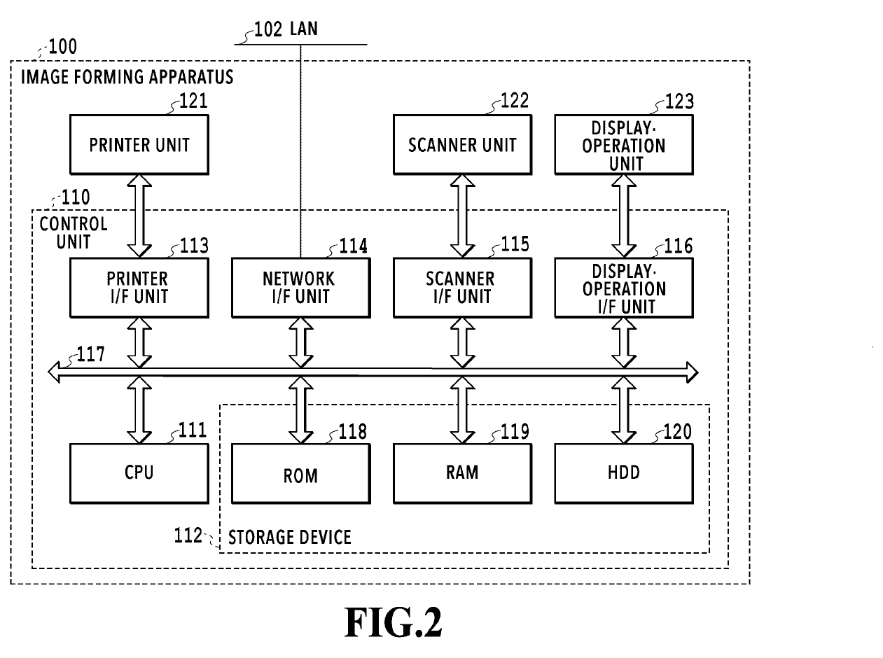

The image forming apparatus 100 is a multifunction peripheral (MFP) including a display·operation unit 123 (see FIG. 2), a scanner unit 122 (see FIG. 2), a printer unit 121 (see FIG. 2), and the like. The image forming apparatus 100 can be utilized as a scan terminal for scanning an original document by using the scanner unit 122. In addition, the image forming apparatus 100 includes the display·operation unit 123 such as a touch panel or hard buttons, and displays a file name and a recommendation result for a storage destination, and displays a user interface configured to receive instructions from the user, and the like.

### Hardware Configuration of Image Forming Apparatus 100

FIG. 2 is a block diagram showing a hardware configuration of the image forming apparatus 100. The image forming apparatus 100 of the present embodiment includes the display·operation unit 123, the scanner unit 122, the printer unit 121, and a control unit 110.

The control unit 110 is an information processing apparatus including a CPU 111, a storage device 112 (a ROM 118, a RAM 119, and an HDD 120), a printer I/F unit 113, a network I/F unit 114, a scanner I/F unit 115, and a display·operation I/F unit 116. In addition, in the control unit 110, these units are communicatively connected to one another via a system bus 117. The control unit 110 controls the operation of the entire image forming apparatus 100.

The CPU 111 functions a unit which executes each processing such as reading control, image processing, and display control in flowcharts described later, by reading and executing a control program stored in the storage device 112.

The storage device 112 stores and holds the control program, image data, metadata, setting data, processing result data, and the like. The storage device 112 includes the ROM 118, which is a non-volatile memory, the RAM 119, which is a volatile memory, the HDD 120, which is a large-capacity storage area, and the like. The ROM 118 is a non-volatile memory which holds the control program and the like, and the CPU 111 reads out the control program to perform the control. The RAM 119 is a volatile memory which is used as a temporary storage area such as main memory or a work area for the CPU 111.

The network I/F unit 114 connects the control unit 110 (image forming apparatus 100) to the LAN 102 via the system bus 117. The network I/F unit 114 transmits image data to an external device on the LAN 102 and receives various pieces of information from an external device on the LAN 102.

The scanner I/F unit 115 connects the scanner unit 122 and the control unit 110 via the system bus 117. The scanner unit 122 reads an original document to generate scanned image data, and inputs the scanned image data into the control unit 110 via the scanner I/F unit 115. Note that the scanner unit 122 includes a document feeder, and is capable of feeding a plurality of original documents placed on a tray one by one and successively reading the plurality of original documents.

The display·operation I/F unit 116 connects the display·operation unit 123 and the control unit 110 via the system bus 117. The display·operation unit 123 includes a liquid-crystal display unit having a touch panel function, hard buttons, or the like.

The printer I/F unit 113 connects the printer unit 121 and the control unit 110 via the system bus 117. The printer unit 121 receives image data generated in the CPU 111 via the printer I/F unit 113, and performs print processing on print sheet by using the received image data. In this way, the image forming apparatus 100 according to the present embodiment is capable of providing image processing functions with the above-described hardware configuration.

### Functional Configuration of Image Forming Apparatus

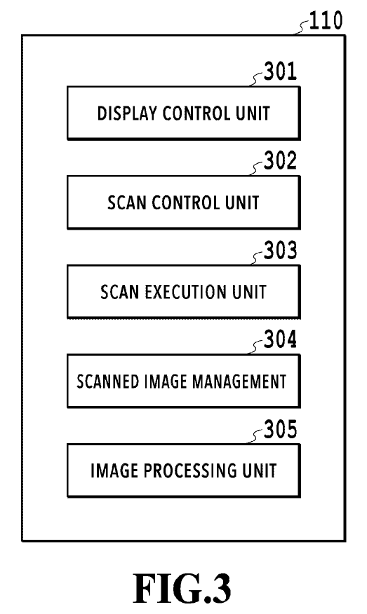

FIG. 3 is a block diagram showing a functional configuration implemented by the control unit 110 of the image forming apparatus 100. Note that the functional configuration shown in FIG. 3 is only a functional configuration involved in processing from scanning an original document to extract items up to saving, among all functional configurations implemented by the control unit 110.

A display control unit 301 displays a user interface screen (UI screen) for receiving various user operations on the touch panel of the display·operation unit 123. The various user operations include, for example, scan setting, an instruction to start scan, setting of item extraction, an instruction to correct an item name, an instruction to save a result of extraction in a file.

A scan control unit 302 instructs a scan execution unit 303 to execute scan processing using scan setting information in response to a user operation (for example, pressing down a "Start scan" button) made in the UI screen. In accordance with the instruction to execute scan processing from the scan control unit 302, the scan execution unit 303 causes the scanner unit 122 to execute an operation of reading an original document via the scanner I/F unit 115 to generate scanned image data. The generated scanned image data is saved in the HDD 120 by a scanned image management unit 304.

An image processing unit 305 performs character string extraction on scanned image data, item name extraction of extracting an item name from an extracted character string, item extraction of extracting a character string corresponding to an item name, and creation of a file for saving a result of extraction. The image forming apparatus 100 also functions as an image processing apparatus with the image processing unit 305. Note that the detail of image processing will be described later.

The function of each unit in FIG. 3 is implemented by the CPU 111 of the control unit 110 deploying a program code stored in the ROM 118 onto the RAM 119 and executing the program code. Alternatively, part or all of the function of each unit in FIG. 3 may be implemented by hardware, such as ASIC or an electronic circuit.

### Detail of Processing

In the present embodiment, in a system which automatically extracts, as a character string, an item value corresponding to an item name from scanned image data, a list of candidates for the item name is presented based on the scanned image data, and the setting of item extraction is performed based on an item name selected by the user. Hereinafter, the setting of an extraction rule by the user and item extraction processing based on the set extraction rule will be described.

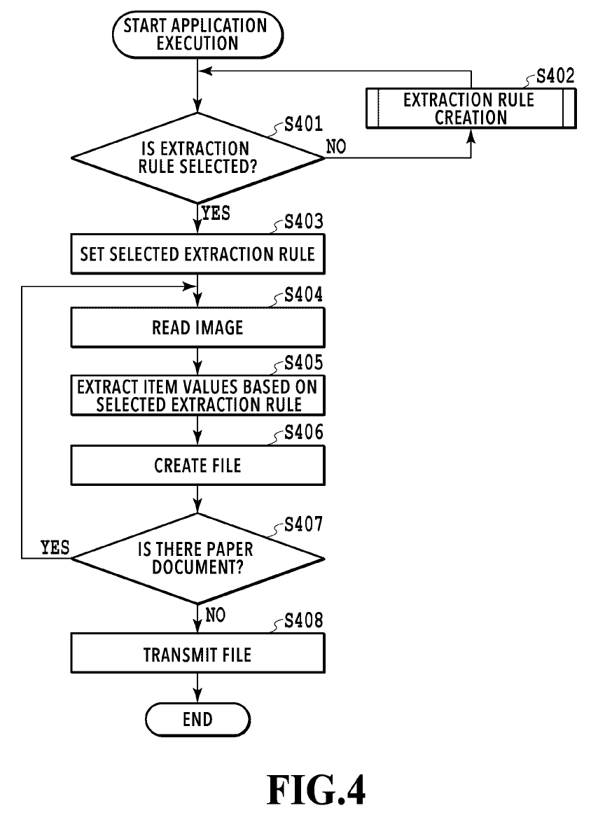

A series of processing shown by a flowchart shown in FIG. 4 is performed by the CPU 111 of the image forming apparatus 100 deploying a program code stored in the ROM 118 onto the RAM 119 and executing the program code. In addition, the functions of some or all of steps in FIG. 4 may be implemented by hardware such as ASIC or an electronic circuit. Note that the mark "S" in the description of each processing means a step in the flowchart, and the same applies to subsequent flowcharts.

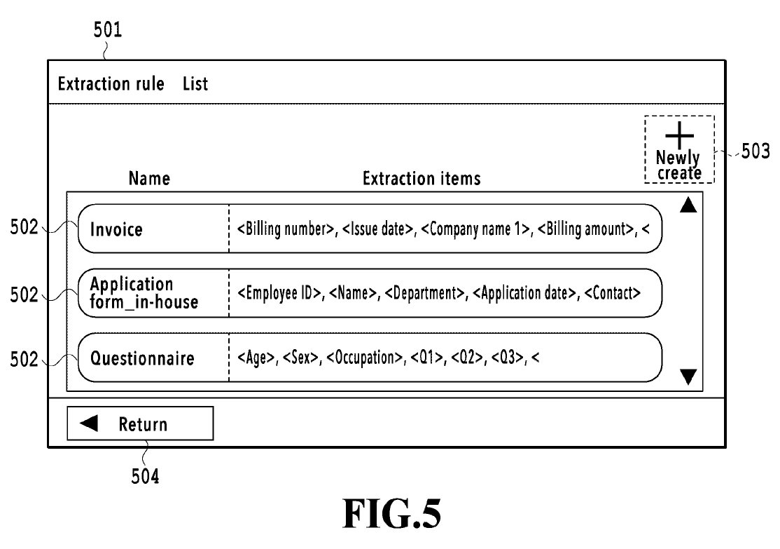

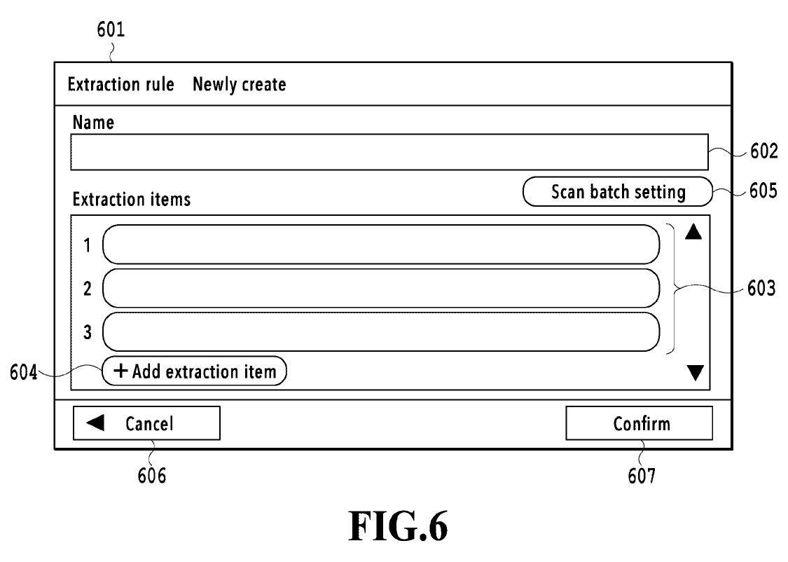

The image forming apparatus 100, in a normal state, displays, on the display·operation unit 123, a main screen in which buttons for implementing each function to be provided are arranged. By installing an additional application which automatically extracts an item in image data into the image forming apparatus 100, buttons for using the functions of the application are displayed on the main screen. By pressing down a button for calling up the application which automatically extracts an item in image data, a screen for setting the item extraction and selecting a set extraction rule is displayed on the display·operation unit 123, and the processing shown in FIG. 4 is executed. FIG. 5 shows an example of an extraction rule list screen to be presented to the user. An extraction rule list screen 501 is displayed as an initial screen in S401. An extraction rule button 502 is a button for setting an extraction rule set in advance for each type of original document, and is created in an extraction rule new creation screen shown in FIG. 6 which is displayed by the pressing down of a new creation button 503. In the extraction rule button 502, a name and an extraction item group of an extraction rule which is used for the display on the screen are displayed in pair. A return button 504 is a button for transitioning to the previous screen, and in the present embodiment, transitioning to the main screen of the image forming apparatus 100.

In S401, the display control unit 301 receives, from the user, the selection of an extraction rule displayed on the extraction rule list screen 501. In a case where the user has pressed down the extraction rule button 502 to select an extraction rule, the processing proceeds to S403, and in a case where the user has pressed down the new creation button 503 to newly create an extraction rule without selecting an extraction rule, the processing proceeds to S402.

In S402, the control unit 110 creates an extraction rule. FIG. 6 shows an example of an extraction rule new creation screen in the present embodiment. An extraction rule new creation screen 601 includes a name entry field 602 and an extraction item entry field 603, and inputs of the user which are received by the display control unit 301 through a software keyboard are displayed in these entry fields. The software keyboard is displayed on the display·operation unit 123 upon selection of an entry field. By pressing down an extraction item adding button 604, the number of the extraction item entry fields 603 is incremented by one. A scan batch setting button 605 is a button for collectively setting the extraction item entry fields 603

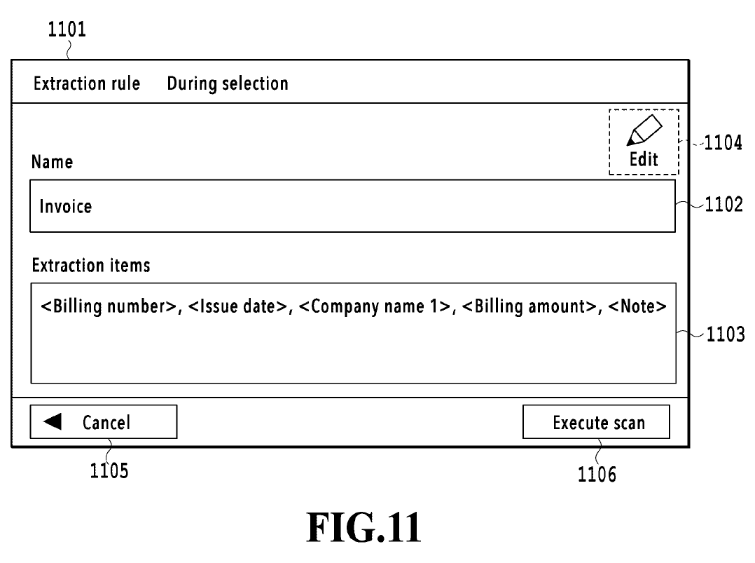

based on scanned image data of a scanned business form. By pressing down a cancel button 606, the inputted content is reset, and the screen is returned to the screen before the transition, which is shown in FIGS. 5 or FIG. 11. By pressing down a confirmation button 607, an extraction rule button 502 is created from the contents inputted into the name entry field 602 and the extraction item entry field 603, and the screen transitions to the screen before the transition, which is shown in FIGS. 5 or FIG. 11.

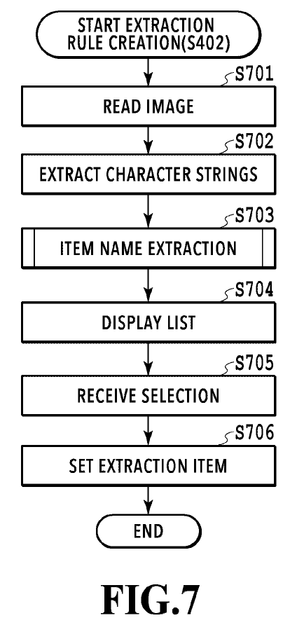

FIG. 7 shows a flowchart for explaining extraction rule creation processing in the present embodiment. By pressing down a scan batch setting button 605 in the extraction rule new creation screen 601, a scan execution button is displayed on the display·operation unit 123, and by pressing down the scan execution button, the processing shown in FIG. 7 is executed.

In S701, upon receipt of a scan instruction of the user via the display·operation unit 123, the scan control unit 302 causes the scan execution unit 303 to read (scan) a paper document from the tray of the document feeder of the scanner unit 122. Then, the scan control unit 302 obtains scanned image data from the scanner unit 122.

In S702, the image processing unit 305 performs the character string extraction on the scanned image data obtained in S701. Specifically, the image processing unit 305 performs block selection on the entire scanned image data to obtain coordinate information of character string blocks, and performs OCR (optical character recognition) on all the character string blocks to obtain character codes of character strings. As a result of this, the image processing unit 305 obtains character recognition information which contains the coordinate information of the character string blocks included in the scanned image data and the character codes of the character strings (also referred to simply as character strings). For example, character recognition information in JSON format in which a character string and coordinate information are described in a hierarchical structure is obtained for each text separated from surrounding characters by a blank on the scanned image data. In a case where all characters are connected like a natural sentence, a morphological analysis is applied to divide the sentence into words.

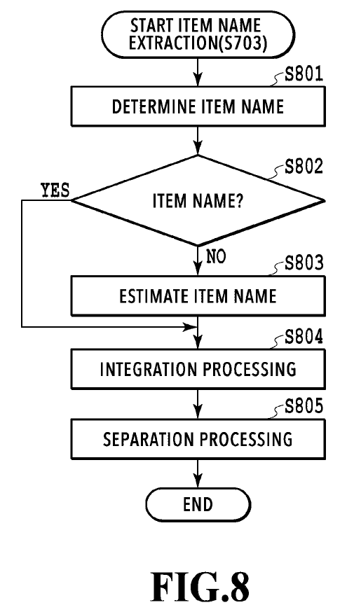

In S703, the image processing unit 305 performs the item name extraction on the character recognition information obtained in S702. FIG. 8 shows a flowchart for explaining a series of processing of the item name extraction in the present embodiment.

In S801, the image processing unit 305 determines item names based on the character recognition information obtained in S702. The means for determining an item name is not particularly limited, and a publicly-known technology can be used. For example, it is possible to use a method that prepares a dictionary encompassing general item names, and determines a character string that is included in image data and coincides with a character string in the dictionary as an item name, and a method that determines an item name by using a machine learning model that learned in advance to determine an item name. Note that the means for estimating an item name is not limited to the above-described methods, and may be a method other than the above-described method.

In S802, the image processing unit 305 determines whether or not each character string block in the character recognition information is an item name. An item that is determined to be an item name in S801 skips S803, and only an item that is not determined to be an item name in S801 proceeds to S803.

In S803, the image processing unit 305 estimates an item name for a character string that is not determined to be an item name in S801. A character string to be subjected to the estimation of an item name in S803 is a character string of an item value described in the document, and includes a character string of an item value whose corresponding item name is described in the document and a character string of an item value whose corresponding item name is not described in the document. As an item value whose corresponding item name is not described in a document, for example, it is often the case that the corresponding item names, such as title, date, and company name, are not specified in a document, and thus there is a case where these character strings correspond. The method for estimating an item name includes, for example, a method in which regular expressions representing formats used in date, amount, telephone number, and the like are used, and in a case where there is a regular expression that coincides with a character string subjected to the estimation, an item name indicated by the coincident regular expression is estimated as an item name of the character string subjected to the estimation. In addition, there is also a method in which a company dictionary that stores names of legal entities of companies, an address dictionary that stores names of addresses, and the like are prepared, and in a case where a character string subjected to the estimation coincides with a character string in these dictionaries, an item name (a company or an address) corresponding to these dictionaries is estimated as an item name of the character string subjected to the estimation. In addition, such a method that uses a machine learning model that has learned in advance to extract an item value corresponding to a predetermined item name, and estimates an item name of an extracted item value may also be employed. Note that the means for estimating an item name is not particularly limited to the above-described methods like the means for determining an item name, and may be a method other than the above-described methods.

In S804, the image processing unit 305 performs integration processing on the item names obtained in S801 and S803. The integration processing is to integrate item names into one in a case where there are item names and item values corresponding to the item names. Since the item values used for the estimation of an item name in S803 also include item values corresponding to item names determined from the character recognition information in S801, a larger number of item names than the item names present in the business form are obtained. For this reason, an item name determined in S801 and an item value that corresponds to the item name and is used for the estimation in S803 are associated with each other by using the coordinate information included in the character recognition information, and the associated item name and an item name estimated from the item value are integrated into one. Although in the present embodiment, an item name determined in S801 is used as an item name after the integration, an item name estimated in S803 may be used as an item name after the integration.

In S805, the image processing unit 305 performs separation processing on the item names subjected to the integration processing in S804. The separation processing is to change item names corresponding to different item values to unique names to distinguish these item names in a case where character strings of item names corresponding to the different item values that have remained after the integration processing coincide with each other. There is also a case where a plurality of item values corresponding to an item name of date, amount, company name, personal name, or the like are present in a single piece of image data, the separation processing is performed to distinguish these. For example, different numbers are added after item names to obtain company name 1 and company name 2.

In this way, by the series of processing shown in FIG. 8, a list of item names is extracted from scanned image data. After the extraction processing of item names is completed, the processing proceeds to S704. Note that the processing of S801 to S803 may be implemented by one learning model. For example, in a case where there are a plurality of categories such as date, amount, company name, and personal name, a machine learning model that has learned in advance to classify a character string as to which category the character string belongs to, the item name or the item value (e.g.: an item name of date, an item value of amount, or the like) is used. In a case where a character string is classified into the item name, the category is the item name (corresponding to S801), and in a case where a character string is classified into the item value, the category is the item name (corresponding to S803). Moreover, based on the character recognition information obtained in S702, an item name is estimated for each character string block in the character recognition information, and a list of item names is outputted.

In S704, the display control unit 301 displays the list of item names extracted in S703 on the touch panel of the display·operation unit 123.

In S705, the display control unit 301 receives, from the user, selection of item names to be extracted from the list of item names displayed on the display·operation unit 123.

In S706, the display control unit 301 sets and registers item names selected in S705 as extraction items for the extraction rule to be created.

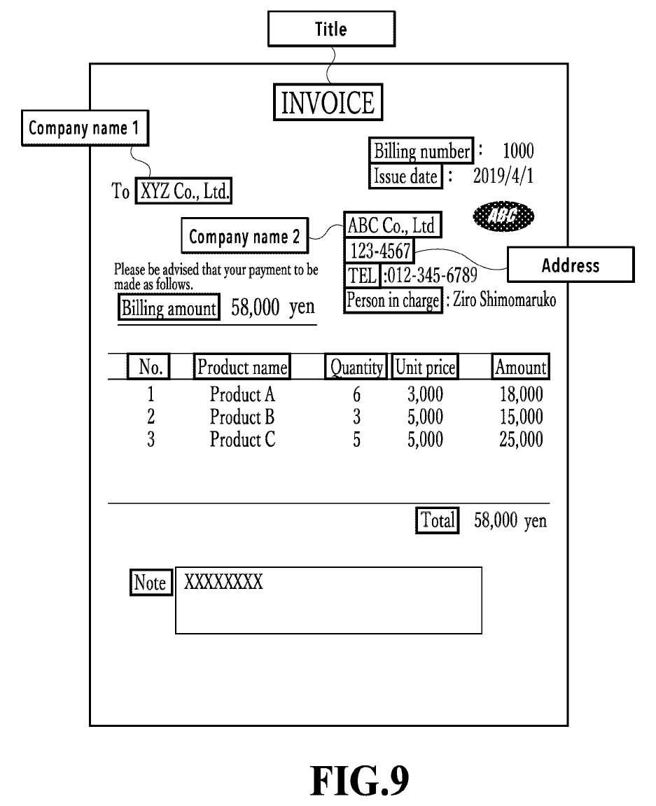

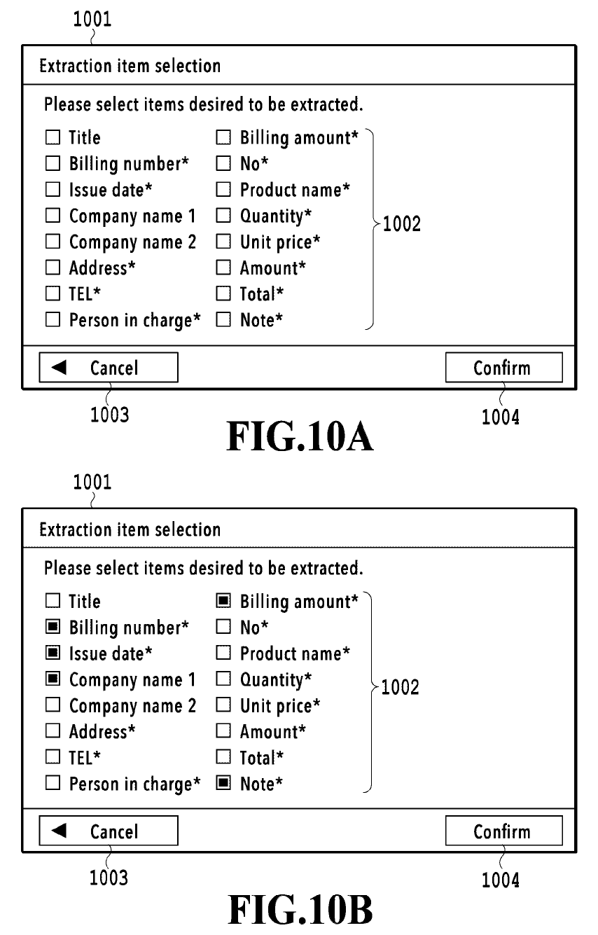

Here, FIG. 9 shows an example of scanned image data from which to extract item names, and FIGS. 10A and FIG. 10B show an example of an extraction item selection screen. In the image data shown in FIG. 9, "Billing number", "Issue date", "TEL", "Person in charge", "Billing amount", "No.", "Product name", "Quantity", "Unit price", "Amount", "Total", "Note" are described as item names. To item values for which item names are not specified, general item names like "Title", "Company name 1", "Company name 2", and "Address" that can be estimated from the respective item values are added. FIG. 10A is the extraction item selection screen before the user selects item names corresponding to item values to be extracted, and FIG. 10B is the extraction item selection screen after the user selected item names. An extraction item selection screen 1001 is a screen that is displayed after the scan batch setting button 605 is pressed down and S703 is completed. An extraction item candidate group 1002 is a list of item names extracted in S703. The item names are arranged in priority order from the top to the bottom and from the left to the right based on position information on the extraction items on the scanned image data. The order to be displayed in the list of item names may be the order of names or the like. In addition, in FIGS. 10A and FIG. 10B, asterisk (*) is added to item names determined in S801 such that it becomes possible to identify whether or not the item names are item names clearly shown in the scanned image data. This allows the user to easily find correspondence with item names in the scanned image data, and to easily select extraction items. Note that as the identification method, such a method in which other marks are added or the colors of item names are changed may be used. Once the user selects item names, checkboxes on the sides of the item names are turned into selected states as shown in FIG. 10B. By pressing down a cancel button 1003, the inputted content is reset, and the screen returns to the screen before the transition, which is shown in FIG. 6. By pressing down a confirmation button 1004, the screen transitions to the screen before the transition, which is shown in FIG. 6, and items selected among the extraction item candidate group 1002 are set in the extraction item entry field 603. Note that although the extraction item selection screen before the selection in FIG. 10A is displayed in a state where no items are selected, specific items such as items which are frequently used depending on the type of business form, for example, may be set to a state of having been selected in advance. A configuration in which items to be selected in advance can be set by the user in advance may be employed.

In this way, by the series of processing shown in FIG. 7, the setting of items to be extracted in a created extraction rule is made at once based on scanned image data without manual input of item names by the user. By pressing down the confirmation button 607, an extraction rule is created from the content set at once. After the creation of an extraction rule, items to be extracted are set by selecting an extraction rule corresponding to a business form of the same layout or the same type from which to extract the same items.

In S403, the display control unit 301 sets the extraction rule selected by the user as an extraction rule to be used in item extraction. FIG. 11 shows an example of a screen during selection of an extraction rule. An extraction rule selection screen 1101 is a screen which is displayed by pressing down the extraction rule button 502. In a name display field 1102 and an extraction item display field 1103, the name of the extraction rule and item names of item values to be extracted, which are displayed in the extraction rule button 502, are displayed. An edit button 1104 is a button for editing character strings displayed in the name display field 1102 and the extraction item display field 1103. By pressing down the edit button 1104, the screen transitions to the screen shown in FIG. 6, a screen in a state where the contents described in the name display field 1102 and the extraction item display field 1103 are inputted into the name entry field 602 and the extraction item entry field 603 is displayed. By pressing down a cancel button 1105, the screen returns to the extraction rule list screen 501 shown in FIG. 5. By pressing down a scan execution button 1106, the extraction rule that is currently selected is set to be applied to subsequent processing, and the processing proceeds to the next step.

In S404, upon receipt of a scan instruction of the user via the display·operation unit 123 through pressing down the scan execution button 1106, the scan control unit 302 causes the scan execution unit 303 to execute the reading (scan) of a paper document. The scan execution unit 303 reads a plurality of paper documents from the tray of the document feeder of the scanner unit 122 one by one. Then, the scan control unit 302 obtains scanned image data generated as a result of the scan.

In S405, the image processing unit 305 performs, on the scanned image data obtained in S404, item extraction of extracting character strings which serve as item values corresponding to item names designated in the extraction rule set in S403. The method for extracting items is not particularly limited, and a publicly-known technology can be used. For example, there are a method that searches scanned image data for a character string of an item name serving as a key, and on a rule base using the key character string thus found as a reference, extracts character strings which are around the key character string, and which serve as item values, and a method that utilizes coordinate information and font sizes to extract character strings which correspond to item names and serve as item values. Alternatively, character strings corresponding to item names may be extracted by a method that uses regular expressions or a method that uses a machine learning model in the same manner as in the item name estimation of S803.

In S406, the image processing unit 305 creates a file by using character strings of specific items extracted in S405 based on the extraction rule. In the present embodiment, a file to be created is described as a CSV file in order to output extracted character strings, but is not limited to this. Character strings extracted in another file format or file name may be utilized. In the case of a CSV file, the CSV file is opened, and if there is no header, header names are entered in the first row, and extracted character strings are entered in the second row. If there has already been headers, extracted character strings are entered in the last row. Note that the header names are item names set in the extraction rule.

In S407, the scan control unit 302 determines whether there is a paper document on the tray of the document feeder of the scanner unit 122. If there is a paper document, the processing returns to S404. If there is no paper document, the processing proceeds to S408.

In S408, the scanned image management unit 304 adds an identifiable file name such as date and time of the transmission to the CSV file created in S407, and transmits the CSV file to a predetermined transmission destination through the LAN 102. Note that as the file name, an input of a character string may be received from the user on a UI screen displayed by the display control unit 301 to use the inputted character string. Alternatively, an entry field for a file name may be provided in the setting screen of an extraction rule, so that the file name can be added.

Then, the series of the flow shown in FIG. 4 is ended. Note that although in the present embodiment, writing into a CSV file is performed every time a paper document is read, it is also possible to store character strings extracted from each paper document, and perform writing into a file after all the paper documents are read. In addition, although in the present embodiment, a CSV file is newly created, a configuration in which writing is additionally performed into an existing CSV file may be employed. In this case, the configuration can be achieved by a method that disposes a button that allows for selection on whether to perform overwriting or additional writing in a case where the same file name as the entry field of file name is present in the setting screen of the extraction rule, or similar methods.

As described above, the present embodiment can reduce the opportunity of manual input in setting item extraction in a case of automatically extracting, from scanned image data, item values corresponding to item names as character strings, and can thus reduce time and effort in setting item extraction by manual input. As compared with the setting made by manually inputting character strings of item names, in a case where the setting can be performed by only selecting item names from a list of item names like the present embodiment, time taken for the setting can also be reduced.

### Second Embodiment

In the present embodiment, text generation models are used in item name extraction in creating an extraction rule and item extraction based on the extraction rule. In the description of the present embodiment, descriptions of parts having the same configurations and processing procedures as those in the first embodiment will be omitted, and only parts having differences will be described.

### Detail of Processing

Differences between the present embodiment and the first embodiment are item name extraction of S703 in S402, which is the processing of creating an extraction rule, and item extraction based on the extraction rule of S405. Although in the first embodiment, S703 is configured with S801 to S805, it becomes possible to perform the processing of S801 to S805 as single processing by using a text generation model.

In S703, the image processing unit 305 performs item name extraction on scanned image data obtained in S701. In the present embodiment, the item name extraction of S703 is performed by using a text generation model. This text generation model for item name extraction is a kind of a machine learning model that has learned by using a large amount of text data and generates a new text based on given input data. Note that as the text generation model, a publicly-known model may be used. Representative text generation models include a Transformer model and the like. General learning methods include supervised learning and self-supervised learning. In the supervised learning, a model is trained by using pairs of input data and correct answer data corresponding to the input data. On the other hand, in the self-supervised learning, a model itself proceeds with learning by predicting part of data. Text generation models are utilized in various application fields, like the generation of sentences, translation, summarization, dialogue system, and the like. In the present embodiment, character recognition information of the entire scanned image data and an instruction for item name extraction are inputted as a prompt into a text generation model for item name extraction, and a list of item names corresponding to item values included in the scanned image data is obtained. The character recognition information is the same information as in the first embodiment. In this event, inside the text generation model for item name extraction, item names are specified from the content of the character recognition information in accordance with the instruction of the inputted prompt. In addition to item names directly described in the scanned image data, item names are inferred from item values for which no item names are described. This becomes possible by understanding an instruction of a prompt into which the text generation model for item name extraction is inputted, and also analyzing a context and a structure of the inputted character recognition information to determine item names or item values and grasp a correspondence relation from position information for each text.

By executing the processing as described above, item names in scanned image data can be comprehensively extracted as long as the item names are of general items.

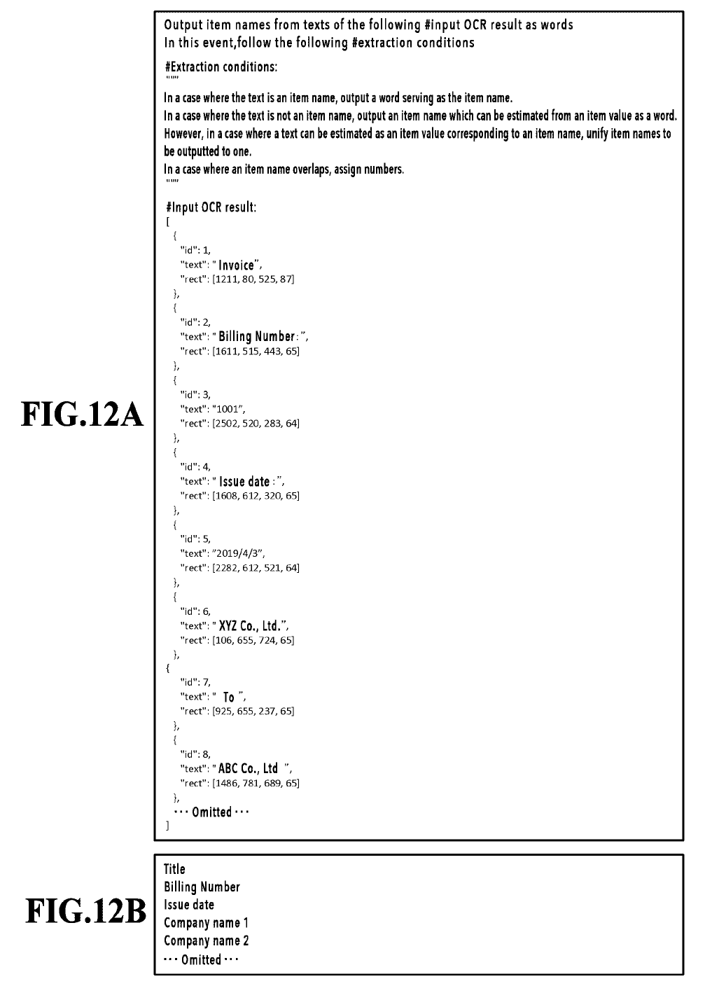

FIG. 12A shows a specific example of a prompt for item name extraction to be inputted into a text generation model for item name extraction. In the example shown in FIG. 12A, an instruction to output item names from an input OCR result and an instruction to output item names that can be inferred from item values are given. If there are only these two instructions, in a case where both item names and item values are described, some item names become redundant, and thus an instruction to prevent the redundancy is also given. In addition, also given is an instruction to output item names with numbers in a distinguishable manner in a case where item names corresponding to different item values are the same character string. The above-described instructions correspond to the processing of S801 to S805. The input OCR result inputted into the text generation model for item name extraction is a result obtained by performing block selection and OCR on the scanned image data shown in FIG. 9. Here, the input OCR result is obtained in the JSON format described in a hierarchical structure for each character string independent from surrounding characters with a blank on the scanned image in the character string extraction of S702, and thus is basically separated on an item name or item value unit basis. Even if item values corresponding to an item name and an item name are connected, there is no problem because the integration of the item names is performed in the first place. In addition, in a case where all characters are connected like a natural sentence, since a morphological analysis is applied to divide the sentence into words in the character string extraction of S702, the item names or the item values are separated.

FIG. 12B shows an example of output of the text generation model for item name extraction in the present embodiment. This example of output is a result of output obtained in a case where the prompt shown in FIG. 12B is inputted into the text generation model. A list of item names is outputted from input OCR information in accordance with the instruction without redundancy.

In S405, the image processing unit 305 performs, on the scanned image data obtained in S404, item extraction of extracting character strings to be item values corresponding to the item names designated in the selected extraction rule. In the present embodiment, the item extraction is also performed by using a text generation model. Into this text generation model for item extraction, coordinate information of character string blocks included in the scanned image data and character recognition information containing character codes of the character strings, as well as item names designated in the extraction rule set in the S403 are inputted as a prompt. In this way, item values corresponding to the item names are outputted from the text generation model for item extraction.

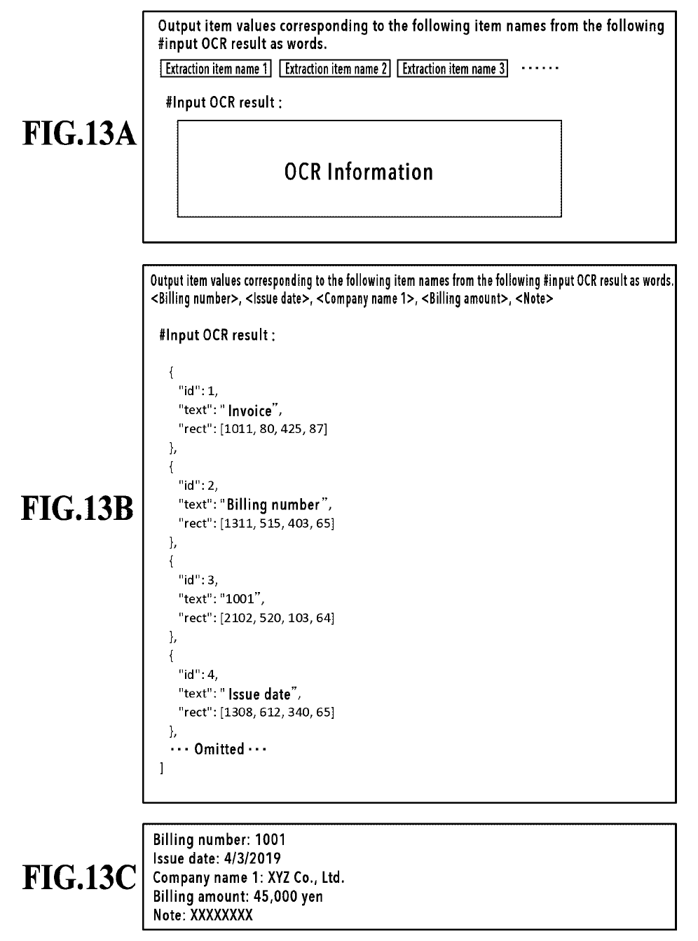

FIG. 13A shows an example of a format of the prompt for item extraction to be inputted into the text generation model for item extraction in the present embodiment. Extraction item names 1 to 3 indicate placeholders. FIG. 13B shows a specific example of the prompt to be inputted into the text generation model for item extraction in the present embodiment. FIG. 13C shows an example of output in a case where the prompt shown in FIG. 13B is inputted into the text generation model for item extraction in the present embodiment. The text generation model for item extraction outputs item values corresponding to the respective item names designated in the extraction rule from the character recognition information.

Several examples of item extraction on the scanned image data shown in FIG. 9 will be described on the assumption that a prompt in the same format as the prompt shown in FIGS. 13A to FIG. 13C is inputted into the text generation model for item extraction. For example, in a case where <title> is inputted into the text generation model for item extraction as extraction item name 1 in FIG. 13A, "Invoice" is outputted as an item value corresponding to <title>. The text generation model can understand a structure even without description of the item name in a business form, and output an appropriate item value. Similarly, in a case where <number> is inputted into the text generation model for item extraction as extraction item name 1, "1001", which is a billing number, is outputted as an item value corresponding to <number>. On the other hand, in a case where <amount> is inputted into the text generation model for item extraction as extraction item name 1 in order to extract a billing amount, any of amounts described in a detail list is outputted as an item value corresponding to <amount>. Although it is possible to output an appropriate item value even in a case where there is a certain degree of variations in notation in an extraction item name to be inputted into the text generation model, the accuracy is improved by using a notation close to a notation used at the time of learning. Note that the above-described instruction message is an example, and it is desirable to perform input adapted to the characteristics of the text generation model.

The item name extraction to be performed at the time of creating an extraction rule and the item extraction based on the extraction rule, which use text generation models in this way, have been described. The text generation model can be universally applied to various business forms as long as general item names are included because of its characteristics obtained by learning using a large amount of text data. For this reason, as long as item values to be extracted are the same, not only business forms of the same layout or the same type, but also various types of business forms can be handled with the same extraction rule. For this reason, the number of settings in an extraction rule can be reduced as compared with the first embodiment. In addition, by using a text generation model in item name extraction to be performed at the time of creating an extraction rule, it becomes possible to more comprehensively extract item names, so that item names that are not derived are reduced as compared with the first embodiment. This can further reduce the opportunity of manually inputting item names, and can reduce time and effort in setting item extraction by manual input more.

### Third Embodiment

In the first and second embodiments, in a case where an item name extracted by the item name extraction is present in scanned image data, the item name is displayed as it is. In addition, in a case where an item name for an item does not exist on scanned image data and there are a plurality of the same item names, the item names are distinguished and displayed with numbers. However, if notations on scanned image data are used as they are, in a case where a business form is special, there is a possibility that the notations are difficult to recognize as they are. In addition, in a case where notations vary and are not uniform among extraction rules, there is also a possibility that misrecognition occurs for an item corresponding to an item name. For example, regarding an amount of invoices, in a case where item names are different among business forms like "Billing amount", "Total amount", "Your invoice amount", "Total amount (including tax)", an item name to be displayed varies depending on a business form scanned in performing the item name extraction. Item names distinguished with numbers also have a problem that in a case where a specific item is desired to be obtained, it is difficult to identify which item name corresponds to an item desired to be obtained. In the present embodiment, item names to be displayed as a list are changed to uniform notations among extraction rules, or to notations representing the contents of the items in further detail so as to be easily selected. In the description of the present embodiment, descriptions of parts of the same configurations or processing procedures as in the first and second embodiments will be omitted, and only part having differences will be described.

### Detail of Processing

Differences from the first and second embodiments are integration processing of S804 and separation processing of S805, and S804 and S805 in the present embodiment will be described below.

In S804, the image processing unit 305 performs integration processing on item names obtained in S801 and S803. In the integration processing in the present embodiment, a dictionary in which an item name group in which there are a plurality of item names representing the same item to cause a variations in notation is associated with a single unified item name is prepared. In a case where there is an item name that coincides with an item name that is stored in the dictionary and causes a variations in notation, the item name is converted and integrated to a unified item name. An item name group relating to an amount in invoices is all integrated into a unified item name, for example, "Billing amount". Besides, it can be considered to integrate "Billing number", "Invoice number", and "Invoice No." into "Invoice number", and to integrate "Billing year, month, and date", "Billing date", and "Document date" into "Billing date".

In S805, the image processing unit 305 performs separation processing on the item name subjected to the integration processing in S804. In the separation processing in the present embodiment, in a case where there are the same item names, the same item names are not distinguished by adding different numbers to the same item names, but are distinguished by converting the same item names to item names representing details of the contents of the items. A dictionary in which a unified item name and detailed item names are associated with each other is prepared, and based on a determination rule using character strings around an item name of interest, coordinate information, layout information, and the like, the item name is converted in a case where the item name matches a condition. For example, in the scanned image data shown in FIG. 9, company name 1 and company name 2 can be converted to different detailed item names like "Company name of billing destination" and "Company name of issuance origin".

Based on the arrangement of "XYZ Co., Ltd." and "ABC Co., Ltd." and information on surrounding character strings such as "To", "XYZ Co., Ltd." is determined to be "Company name of billing destination" and "ABC Co., Ltd." is determined to be "Company name of issuance origin". Besides, it can be considered to convert "Person in charge" to different detailed item names like "Person in charge in the other party" and "Person in charge in the own company", and to convert "Personal number" to detailed item names like "Personal number (person him/herself)" and "Personal number (partner)". Information such as the presence or absence of a surrounding specific character string, an arrangement relation in a business form, a group on a layout such as a table can also be used for the determination rule. Note that for item names for which different detailed item names are not found, coordinate positions may be used to display "Company name (near the upper left side)" and "Company name (near the center right side)", or the like.

The methods for the integration processing and the separation processing on a rule base have been mainly shown so far, the text generation model described in the second embodiment may also be utilized. In the case of the integration processing, a prompt like "Please convert XXX to a general item name" is inputted. Note that the integration processing may be performed not only on an item name that coincides with a dictionary of items that cause variations in notation, but also on all obtained item names. In the case of the separation processing, a prompt like "Please convert XXX to a detailed item name taking into account the following #input OCR result as well. #input OCR result The rest will be omitted." is inputted. Note that the separation processing may be performed not only when the same item names are present, but also in a case where item names having similar concepts are present. Here, "XXX" is an item name desired to be converted.

In this way, in the present embodiment, by using a unified notation among extraction rules in the integration processing, variations in notation among business forms are absorbed, and an item name that is easy for the user to comprehend and understand can be displayed. On the other hand, in the separation processing, by converting item names distinguished with numbers to detailed notations that clarify the difference, it becomes possible to easily select a specific item desired to be extracted. Since item names to be displayed in a list are converted in this way, it becomes easier for the user to select extraction items in the extraction item selection screen.

The description of the present embodiment is completed with the above.

### Fourth Embodiment

In the first to third embodiments, the item names in the extraction item candidate group 1002 displayed on the extraction item selection screen 1001 shown in FIGS. 10A and FIG. 10B are arranged only in priority order from the top to the bottom and from the left to the right based on the position information on the extraction items on the scanned image data. However, in a case where there a large number of candidates for extraction items, it is hard to select item names of interest from among those displayed candidates. In addition, it is difficult to grasp to which item values in a business form the selected items correspond. In view of this, in the present embodiment, item names in the extraction item candidate group 1002 are grouped and displayed in a hierarchical structure. In addition, item values in a business form are shown together beside item names. In the description of the present embodiment, descriptions of parts having the same configurations and processing procedures as those in the first to third embodiments will be omitted, and only parts having differences will be described.

### Detail of Processing

Differences between the present embodiment and the first to third embodiments are item name extraction of S703 and display of a list of item names of S704.

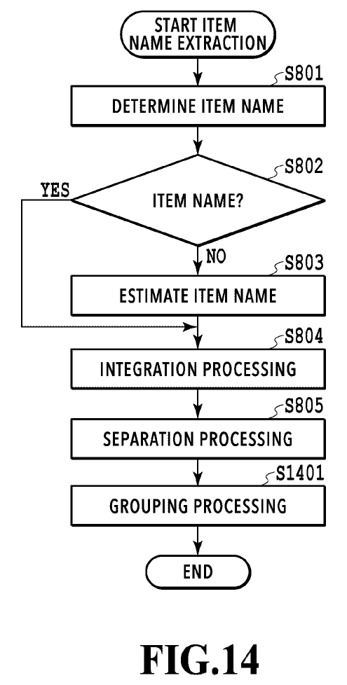

FIG. 14 shows a flowchart for explaining a series of processing of the item name extraction in the present embodiment. In the processing of the item name extraction in the present embodiment, S1401 is added to the processing of the item name extraction shown in FIG. 8.

In S1401, the image processing unit 305 performs grouping processing on item names after the integration processing of S804 and the separation processing of S805 have been performed. For example, by using a dictionary in which general item names prepared in advance and specific item names are associated with each other, item names associated with a general item name are grouped into the same group. Alternatively, by recognizing a table or the like by a layout analysis, items in the table may be grouped into the same group. Specifically, a range serving as a table is calculated, and item names extracted from inside the range are grouped into the same group.

In S704, the display control unit 301 displays, on the touch panel of the display·operation unit 123, a list of item names extracted in S703 taking into account a result of the grouping in S804.

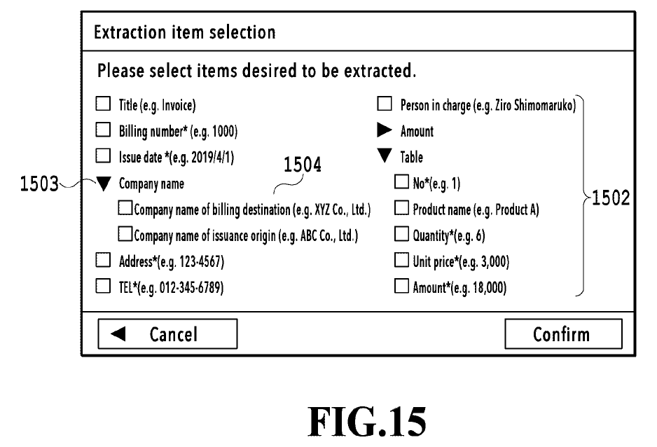

FIG. 15 shows an example of an extraction item selection screen in the present embodiment. An extraction item selection screen 1501 is a screen that is displayed after the scan batch setting button 605 is pressed down and S703 is completed. An extraction item candidate group 1502 is a list of item names extracted in S703. In the extraction item candidate group 1502, a result of the grouping of S1401 is reflected, and items of the same group are displayed in a hierarchical structure. By selecting an arrow button 1503, the arrow button 1503 is alternately changed to a rightward arrow and a downward arrow. In a case where the arrow button 1503 is the rightward arrow, only a general item name of the same group is displayed. In a case where the arrow button 1503 is the downward arrow, a specific extraction item candidate group that can be selected is displayed. An extraction item value example 1504 shows, as examples, item values in image data corresponding to item names obtained from scanned image data used in the scan batch setting.

In this way, in the present embodiment, even in a case where there are a large number of candidates for extraction items, the user is allowed to easily select an extraction item on the extraction item selection screen 1501, by grouping and displaying the extraction item candidate group 1502 in the hierarchical structure and showing item values together with item names. In addition, the user can select an extraction item without discrepancy in recognition of correspondence relations between item names and item values by checking item values shown together.

### Other Embodiments

In the above-mentioned embodiments, the examples in which the image forming apparatus 100 performs the processing of each step of the flowcharts of FIGS. 4, FIG. 7, and FIG. 8 alone. Alternatively, a configuration in which all or part of these processings is performed by another image processing apparatus that has the functions shown in FIG. 3 on the system 105 may be employed.

For example, the scan processing is executed in the image forming apparatus 100, and scanned image data is transmitted to the terminal 101 via the network. The terminal 101 may have the same functions as those of the image processing unit 305, so that the processing is executed in the terminal 101. In this case, the terminal 101 returns a result of the processing to the image forming apparatus 100, and the image forming apparatus 100 generates a file based on the obtained result of the processing, and transmits the file.

According to the present disclosure, registration of an item name corresponding to an item value to be extracted from scanned image can be simply and easily performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-025153, filed February 19, 2025, which is hereby incorporated by reference herein in its entirety.

What is claimed is:

1. An information processing apparatus comprising at least one memory and at least one processor which function as:
an obtaining unit configured to obtain character recognition information for a scanned image of a document;
a deriving unit configured to derive, based on the obtained character recognition information, an item name corresponding to an item value included in the character recognition information; and
a display control unit configured to cause a UI screen to display the derived item name as a candidate of an item name corresponding to an item value to be extracted from a scanned image of a document of the same type as the document, wherein
in a case where an item name corresponding to the item value included in the character recognition information does not exist in the character recognition information, the deriving unit estimates an item name corresponding to the item value based on the item value included in the character recognition information.

2. The information processing apparatus according to claim 1, wherein
the at least one memory and at least one processor further function as:
a registration unit configured to register, as an item name corresponding to the extracted item value, a candidate of the item name selected by a user from among the candidate of the item name displayed on the UI screen.

3. The information processing apparatus according to claim 1, wherein
the character recognition information includes coordinate information of a character string block obtained by performing block selection on the scanned image, and a character string obtained by performing character recognition on the character string block.

4. The information processing apparatus according to claim 1, wherein
the deriving unit includes:
an extraction unit configured to extract, as a first item name, a character string included in the character recognition information; and
an estimation unit configured to estimate a second item name corresponding to a character string included in the character recognition information, and
the deriving unit derives the item name based on the first item name and the second item name.

5. The information processing apparatus according to claim 4, wherein
the display control unit displays the first item name and the second item name on the UI screen in an identifiable manner.

6. The information processing apparatus according to claim 4, wherein
in a case where an item value corresponding to the first item name and an item value corresponding to the second item name are the same, the deriving unit derives only one of the first item name and the second item name as the item name.

7. The information processing apparatus according to claim 4, wherein
the deriving unit converts an item name having the same character string among the first item name and the second item name to a distinguishable item name, and derives the distinguishable item name as the item name.

8. The information processing apparatus according to claim 7, wherein
the distinguishable item name is a more detailed name representing content of an item.

9. The information processing apparatus according to claim 7, wherein
the distinguishable item name includes position information of a corresponding item value on the scanned image.

10. The information processing apparatus according to claim 7, wherein
the deriving unit converts item names which have different character strings but indicate the same item, among the first item name and the second item name to the same item name, and derives the same item name as the item name.

11. The information processing apparatus according to claim 1, wherein
the display control unit displays the derived item name in a hierarchical display according to a type of an item.

12. The information processing apparatus according to claim 1, wherein
the deriving unit derives the item name by using a learning model.

13. The information processing apparatus according to claim 1, wherein
the deriving unit derives the item name in accordance with a condition which the character recognition information satisfies.

14. The information processing apparatus according to claim 13, wherein
the condition is whether the item value matches at least one of a predetermined font size, a predetermined regular expression, and a predetermined coordinate position.

15. An information processing method comprising:
obtaining character recognition information for a scanned image of a document;
deriving, based on the obtained character recognition information, an item name corresponding to an item value included in the character recognition information; and
causing a UI screen to display the derived item name as a candidate of an item name corresponding to an item value extracted from a scanned image of a document of the same type as the document, wherein
in a case where an item name corresponding to the item value included in the character recognition information does not exist in the character recognition information, the deriving step estimates an item name corresponding to the item value based on the item value included in the character recognition information.

16. A non-transitory computer readable storage medium storing a program for causing a computer to perform an information processing method comprising:
obtaining character recognition information for a scanned image of a document;
deriving, based on the obtained character recognition information, an item name corresponding to an item value included in the character recognition information; and
causing a UI screen to display the derived item name as a candidate of an item name corresponding to an item value to be extracted from a scanned image of a document of the same type as the document, wherein
in a case where an item name corresponding to the item value included in the character recognition information does not exist in the character recognition information, the deriving step estimates an item name corresponding to the item value based on the item value included in the character recognition information.
